(19) United States
(12) Patent Application Publication
(10) Pub. No.: US 2018/0037056 A1
(43) Pub. Date: Feb. 8, 2018

(54) INTEGRATED VEHICLE WHEEL SYSTEM OF MODULAR DESIGN

(71) Applicant: Continental Teves AG & Co. oHG, Frankfurt (DE)

(72) Inventors: Johann Jungbecker, Badenheim (DE); Paul Linhoff, Neu-Anspach (DE); Uwe Bach, Niedernhausen (DE); Jens Hoffmann, Darmstadt (DE); Hans-Peter Metzen, Bad Vilbel (DE); Martin Semsch, Maibach-Butzbach (DE)

(73) Assignee: Continental Teves AG & Co. oHG, Frankfurt (DE)

(21) Appl. No.: 15/552,330

(22) PCT Filed: Apr. 5, 2016
(86) PCT No.: PCT/EP2016/057397

§ 371 Date: Aug. 21, 2017

(30) Foreign Application Priority Data
Apr. 15, 2015 (DE) 10 2015 206 830.7

(51) Int. Cl. B60B 23/10; B60B 3/10; B60B 27/00; B60B 3/04

(52) U.S. Cl. CPC B60B 23/10; B60B 3/041; B60B 3/10; B60B 27/0052; B60B 27/0063; B60B 2900/111

(57) ABSTRACT

A vehicle wheel system for motor vehicles includes a central wheel disc having an attachment flange for arrangement on a chassis component, and having a brake rotor which is provided coaxially with respect to a central rotational axis Ax and whose external circumference is secured to the wheel disc but is otherwise freely oriented in the radially inward direction. An aspect is a vehicle wheel system which is of lightweight construction and easy to maintain. The aspect is based on the brake rotor being secured in an exchangeable fashion by a plurality of support sections at its outer circumference with a detachable attachment and, for the purpose of conducting away heat, is secured in a thermally conductive fashion to a plurality of abutment sections on the circumference of the wheel disc, with the result that overall a modular design (MAB) is obtained.

### CROSS REFERENCE TO RELATED APPLICATIONS

This application is the U.S. National Phase Application of PCT International application Ser. No. PCT/EP2016/057397, filed Apr. 5, 2016, which claims priority to German Patent Application No. 10 2015 206 830.7, filed Apr. 15, 2015, the contents of such applications being incorporated by reference herein.

### FIELD OF THE INVENTION

The invention relates to a vehicle wheel system comprising a wheel disk and comprising a rim ring for pneumatic tires by the integration of an internally encompassed brake rotor which is arranged coaxially to a centrally arranged wheel rotational axis and cooperates with at least one wheel brake actuator.

### BACKGROUND OF THE INVENTION

Cost-effective, known axle systems with lightweight wheels are adapted from conventional mass-produced components of known brake systems such that, in spite of the increased rolling radius which is available, the conventional wheel brake configuration is used with a relatively small effective brake radius. Generally, in this case conventional one-piece brake rotors comprising a pot and friction ring made of cast material are also used.

A conventional wheel with a specifically internally encompassed brake disk and with a correspondingly specific sliding caliper of the ATE FR 2 type is disclosed in Breuer/Bill, Bremsenhandbuch, Vieweg Verlag, 3rd Edition September 2006, ISBN-13 978-3-8348-0064-0, page 98 and DE 35 08 039 C2, both incorporated by reference.

In DE 10 2011 079 599 A1, which is incorporated by reference, is disclosed a vehicle wheel constructed in lightweight composite material in a hub-spoke-rim base configuration, primarily from a light metal material, wherein the wheel body is configured in one piece. Free spaces which are integrated in the spokes and additional free spaces which are placed between the spokes are provided in the wheel body. The free spaces between the spokes are hermetically sealed in a planar manner by supporting wall plates bearing on all sides, resulting in low soiling together with improved drag coefficient. The wall plates are designed from fiber-reinforced plastics material with a woven structure and bonded in a durable manner to the wheel body in order to transmit the forces. Moreover, this also results in an attractive visual appearance by avoiding contact corrosion.

A temperature-resistant and creep-resistant reinforced plastics wheel of composite construction comprising a rim ring, a wheel disk with a hub portion and embedded metal reinforcing sleeves in the hub portion is disclosed in GB 2 162 802 A, which is incorporated by reference. The composite wheel is provided, in particular, for arranging on a brake drum.

### SUMMARY OF THE INVENTION

An aspect of the present invention proposes a developed vehicle wheel arrangement, having a lightweight construction which is particularly easy to maintain and which is sturdy, including a brake rotor with an effectively enlarged friction radius, wherein the vehicle wheel which is formed also meets thermal requirements, in particular in sports vehicle applications, at an acceptable cost.

In one aspect of the invention, the brake rotor is secured in an exchangeable fashion by a plurality of support sections on its outer circumference with detachable attachment means and, for the purpose of conducting away heat, is secured in a thermally conductive fashion to a plurality of abutment sections on the circumference of the wheel disk, with the result that a modular design is defined.

An aspect of the invention dispenses with a full composite construction. A vehicle wheel construction which in principle is uniform-modular and of lightweight construction is provided, wherein the wheel disk is configured as a heat sink which is connected in a thermally conductive manner to the brake rotor. The invention permits flexible variation in mass production in a modular system for particularly lightweight disk wheels, by wheel disks which are designed differently, for example, in terms of aesthetics, in terms of materials or in size being simply of modular design and being able to be mounted in an exchangeable manner, for example being able to be combined with (tribologically) differently adapted brake rotor materials and/or rim rings designed to be of different sizes. By the dissipation of the brake heat into the wheel disk the thermal load of the rim ring is reduced, so that a particularly creep-resistant and nevertheless sports-performance construction is defined.

When the brake rotor is configured, in principle, with the support sections in a circular and planar manner, such that the support sections are designed as projections which are shaped radially outwardly on the circumference and which comprise through-bores for receiving components of the attachment means, this permits an effective internally-encompassed brake construction.

An effective drilled portion and screw connection oriented in a uniformly axial manner is permitted by the abutment sections of the wheel disk and the support sections of the brake rotor being clamped relative to one another by attachment means which are oriented so as to pass through axially.

The thermal energy coupling between the brake rotor and the wheel disk is implemented in the region of the bearing and abutment by the relevant components being clamped tightly relative to one another, by the attachment means in each case comprising a retaining bush with an internal thread for a screw bolt with an external thread, and wherein additionally a bearing bush is interposed between the brake rotor and the screw bolt.

The positive securing of the attachment means is such that each retaining bush is axially mounted in a secured manner with a collar on the end side, integrally in an adapted receiving bore of the wheel disk. Moreover, the retaining bush has a hollow wall portion which is designed in one piece, comprising the internal thread for the external thread of the screw bolt. Additionally, the hollow wall portion at least partially penetrates a bore receiver in the support section of the brake rotor. The substantially rotationally cylindrical construction of the components of the attachment means permits both the design thereof by machining as a rotating part, by using specific light metal materials, and the design thereof by forming technology (stamped part, deep-drawn part or pressed part in solid or sheet metal forming technology).

To avoid losses of pretensioning force it is provided that the retaining bush, namely in particular the hollow wall portion, or the screw bolt, in particular the shank thereof, is configured to be deformable in a reversible, resilient manner. By means of the dual function, specific clamping means, in particular specific spring means, may be rationalized.

In a further advantageous-expedient embodiment, attachment interfaces are provided between the abutment sections of the wheel disk and the support sections of the rim ring, said attachment interfaces incorporating centering seats which are configured in a stepped manner between the relevant components and the detachable attachment means. In this case, the positive attachment is configured such that the interfaces on the support sections comprise retaining claws which are bent radially inwardly at right angles and which cooperate with centering seats which are configured in a radially stepped manner on the abutment sections. Accordingly, the mounting sequence of the relevant components is such that the rim ring with the retaining claws which are bent radially inwardly at right angles is positioned and secured axially from the outside onto a wheel disk.

The retaining claws have through-bores for attachment means arranged so as to be oriented in a detachable and uniformly axial manner, so that all of the corresponding advantages relevant thereto may also be gained. Additionally, the attachment means are directly screwed into the wheel disk, so that in principle the handling of nuts or counterpieces is not required, which simplifies the tire replacement with the rim ring directly on the vehicle, since the wheel disk may simply remain on the wheel hub.

Another aspect of the invention, therefore, permits a very simple vehicle wheel which is of uniform construction and yet is able to be designed in a variable manner, with the advantage that very different variations of material may be combined together in a manner which is cost-effective and easy to maintain, and wherein an obligatory adhesively bonded composite construction is avoided.

### BRIEF DESCRIPTION OF THE DRAWINGS

Further features and details of the invention are revealed from the following description with reference to the drawing. In the drawing:

FIG. 1 shows an exploded drawing of the vehicle wheel system including the wheel brake actuator system;

FIG. 2 shows the attachment means between the rim ring and wheel disk as in FIG. 1 in an enlarged exploded view,

FIG. 3 shows the attachment means between the brake rotor and wheel disk as in FIG. 2 in section,

FIG. 4 shows a side view from the right of the vehicle wheel system as in FIG. 1,

FIG. 5 shows a plan view of the vehicle wheel system as in FIG. 1, and

FIG. 6 shows a side view from the left of the vehicle wheel system according to FIG. 1.

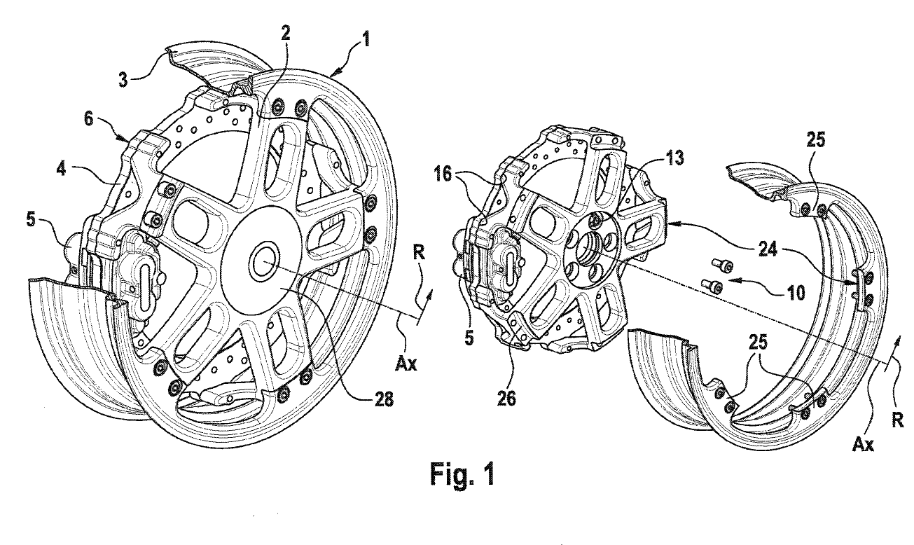

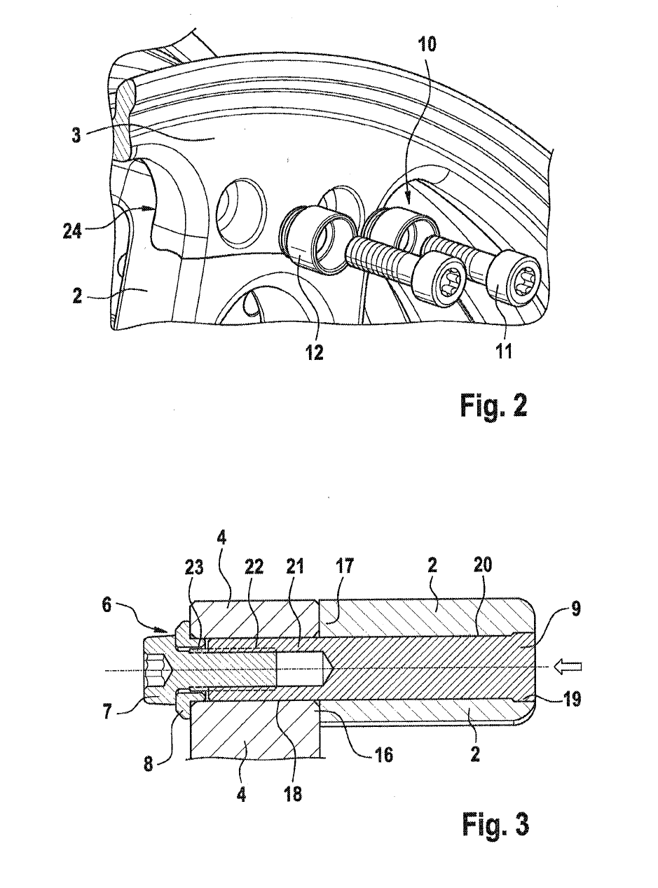

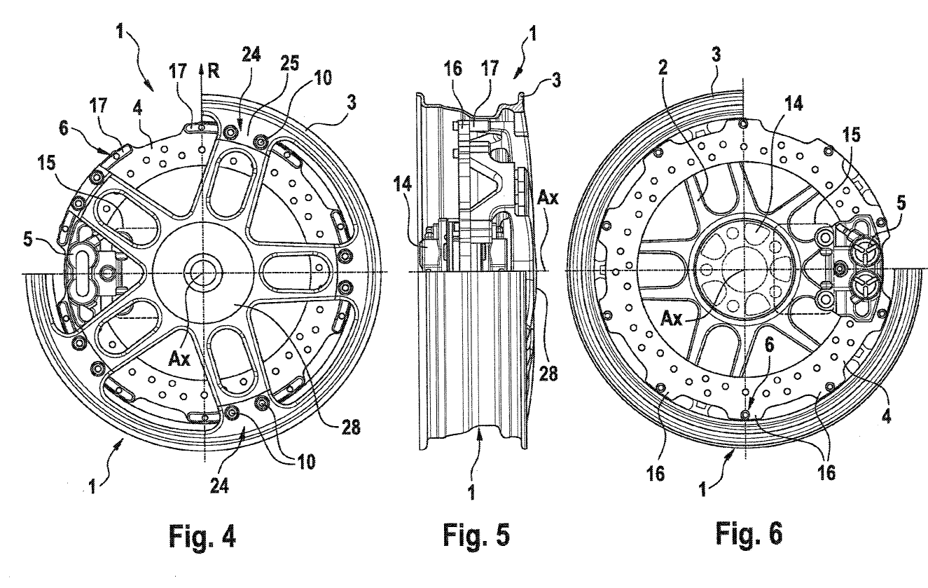

### DETAILED DESCRIPTION OF THE PREFERRED EMBODIMENTS

A vehicle wheel system 1 of lightweight construction comprises the following components which are able to be assembled in a modular manner: p wheel disk 2 (optionally with spokes and preferably produced from a light metal material such as aluminum),

rim ring 3 (preferably produced in one piece from carbon composite material), in particular the entire rim ring 3 may comprise an extremely lightweight and mechanically load-bearing fiber composite material,

internally-encompassed brake rotor 4 without a pot and with external attachment (preferably produced in one piece from a light metal material such as aluminum),

internally-encompassing brake actuator 5 (preferably of fixed caliper construction and preferably produced from aluminum material with the carrier 15),

attachment means 6 for clamping between the brake rotor 4 and the wheel disk 2 with associated components such as a screw bolt 7, bearing bush 8 and retaining bush 9—in each case arranged so as to be axially oriented,

attachment elements 10 between the rim ring 3 and wheel disk 2 comprising the components, such as a screw bolt 11 and a pressure piece 12 integrated in a seat in the rim ring 3—in each case arranged so as to be axially oriented,

attachment means 13 arranged between the wheel disk 2 and the chassis component (hub) 14—in each case axially oriented, i.e. parallel to the rotational axis Ax.

The brake actuator 5 is connected fixedly in terms of rotation via a carrier 15 to a chassis component 14 and transmits the acting braking forces to the vehicle. Preferably, the carrier 15 is structurally integrated on or in a hub 14 in one piece.

The brake rotor 4 is clamped by means of attachment means 6 onto the wheel disk 2 at abutment 17. The attachment means 6 comprise a plurality of components, as follows. A screw bolt 7 is arranged so as to be axially oriented and penetrates a through-bore 18 in the support sections 16 of the brake rotor 4. For the pretensioning, each screw bolt 7 has a head portion, a bearing bush 8 acting thereon. Each bearing bush 8 has a centering collar and is inserted into the through-bore 18 of the brake rotor. In the wheel disk 2 positively stepped receivers 20 for retaining bushes 9 with a collar 19, hollow wall portion 21, and internal threads 22 are arranged, said receivers in each case being engaged with the external threads 23 of the screw bolts 7 at a defined axial pretensioning force (being screwed with a predetermined torque). The retaining bushes 9 or screw bolts 7 which are configured to be substantially rotationally symmetrical may be provided to be axially resilient in order to compensate for the loss of pretensioning force. For producing the attachment means, a light metal material or a heavy metal material may be used as a thin sheet metal initial product from the coil or as a solid material portion for the purpose of chip-removal machining or chipless machining. By means of the through-bores 18 integrated in the support section 16, the brake rotor 4 is centered relative to the wheel disk 2 and at the same time transmits the braking torque produced via the brake actuator 5 reliably to the wheel disk 2. At the same time, by means of screw bolts 7 and the bearing bush 8, the brake rotor 4 is held axially securely in thermally conductive contact. This ensures the optimal function of the heat sink wheel disk 2, i.e. an optimal transmission of heat from the brake rotor 4 to the wheel disk 2.

Defined stepped interfaces 24/a centering seat 26 with attachment elements 10 serve for an (axial/radial) attachment which is flat and centered and without imbalance between the rim ring 3 and the wheel disk 2, said attachment elements being attached in an axially oriented manner and comprising a pressure piece 12 and an associated screw bolt 11 which comprises a head and shank, and with an external thread portion, said pressure piece is screwed into an integral internal thread portion of the wheel disk 2. Each pressure piece 12 is arranged so as to be recessed together with the head of the screw bolt 11 in a stepped receiver of the retaining claw 25 of the rim ring 3.

The pressure pieces 12 are preferably already positively incorporated during the production of a rim ring 3 made of carbon material. The radially and axially centered securing takes place by means of the axially oriented screw bolt 11 and using the interface 24 between the retaining claw 25 and the wheel disk which is configured to be positively stepped and overlapping. Mating threads for the screw bolts 11 are integrated in the wheel disk 2. A detachably secured cover 28 may conceal the wheel attachment means 13, the centering collar between the wheel disk and the hub or the like.

The novel vehicle wheel system 1 permits a novel, advantageous and simplified concept for variation and maintenance in the case of servicing and also in the case of logistics, relative to summer or winter tires. Accordingly, in addition to the novel vehicle wheel concept it is proposed that the wheel disk 2 according to the invention is provided for remaining substantially permanently on the chassis component 14 (hub) of the vehicle, whereas only the rim ring 3 which is detachably mounted on the wheel disk 2 is replaced in each case. This reduces the cost of logistics and additionally permits a novel concept for maintenance.

### LIST OF REFERENCE NUMERALS

1 Vehicle wheel system
2 Wheel disk
3 Rim ring
4 Brake rotor
5 Brake actuator
6 Attachment means
7 Screw bolt
8 Bearing bush
9 Retaining bush
10 Attachment element
11 Screw bolt
12 Pressure piece
13 Attachment means
14 Chassis component
15 Holder
16 Support section
17 Abutment section
18 Through-bore
19 Collar
20 Receiving bore
21 Hollow wall portion
22 Internal thread
23 External thread
24 Attachment interface
25 Retaining claw
26 Centering seat
27 Attachment flange
28 Cover
Ax Rotational axis/axial direction
R Radial direction

1. A vehicle wheel system for motor vehicles comprising a central wheel disk having an attachment flange for arrangement on a chassis component and having an integrated brake rotor which is provided coaxially with respect to a central rotational axis Ax, and whose outer circumference is secured to the wheel disk and is otherwise freely oriented in the radially inward direction, wherein the brake rotor is secured in an exchangeable fashion by a plurality of support sections on its outer circumference with detachable attachment means and, for the purpose of conducting away heat, is secured in a thermally conductive fashion to a plurality of abutment sections on the circumference of the wheel disk.

2. The vehicle wheel system as claimed in claim 1, wherein the brake rotor is configured with the support sections in a circular and planar manner, such that the support sections are designed as projections which are shaped radially outwardly on the circumference and which comprise through-bores for receiving components of the attachment means.

3. The vehicle wheel system as claimed in claim 1, wherein the abutment sections of the wheel disk and the support sections of the brake rotor are clamped relative to one another by attachment means which are oriented axially.

4. The vehicle wheel system as claimed in claim 3, wherein the attachment means in each case comprise a retaining bush with an internal thread for a screw bolt with an external thread, and wherein additionally a bearing bush is interposed between the brake rotor and the screw bolt.

5. The vehicle wheel system as claimed in claim 4, wherein each retaining bush is positively axially secured with a collar on the end side, integrally in an adapted receiving bore of the wheel disk, such that the retaining bush has a hollow wall portion which is designed in one piece, comprising the internal thread for the external thread of the screw bolt, and wherein the hollow wall portion at least partially penetrates the through-bore in the support section of the brake rotor.

6. The vehicle wheel system as claimed in claim 4, wherein the screw bolt and/or the retaining bush is configured to be deformable in a reversible, resilient manner.

7. The vehicle wheel system as claimed in claim 1, wherein attachment interfaces are defined between the abutment sections of the wheel disk and the support sections of the rim ring, said attachment interfaces containing centering seats between the relevant components and the detachable attachment elements.

8. The vehicle wheel system as claimed in claim 7, wherein each interface on the rim ring comprises a retaining claw which is bent radially inwardly at right angles and which cooperates with a centering seat of the wheel disk which is configured in a radially stepped manner.

9. The vehicle wheel system as claimed in claim 8, wherein each retaining claw comprises through-bores for attachment elements arranged so as to be oriented in a detachable and axial manner, and in that the attachment elements are screwed into the wheel disk.

10. The vehicle wheel system as claimed in claim 2, wherein the abutment sections of the wheel disk and the support sections of the brake rotor are clamped relative to one another by attachment means which are oriented axially.

11. The vehicle wheel system as claimed in claim 5, wherein the screw bolt and/or the retaining bush is configured to be deformable in a reversible, resilient manner.
